(19) United States
(12) Patent Application Publication
(10) Pub. No.: US 2017/0355294 A1
(43) Pub. Date: Dec. 14, 2017

(54) Bundle Transport Trailer

(71) Applicant: Garlock Equipment Company, Minneapolis, MN (US)

(72) Inventors: Christopher Scott Bisson, Lambertville, MI (US); Christopher A. Krajnik, Maple Grove, MN (US)

(21) Appl. No.: 15/618,494

(22) Filed: Jun. 9, 2017

Related U.S. Application Data
(60) Provisional application No. 62/348,279, filed on Jun. 10, 2016.

(51) Int. Cl. B60P 1/52; B60P 1/43; B62D 33/04

(52) U.S. Cl. CPC B60P 1/52; B62D 33/04; B60P 1/435

(57) ABSTRACT

A roofing material bundle transport trailer includes a steering assembly and a pair of transport wheels movably supporting a frame upon a support surface. An inner end of a brake pedal grips one of a plurality of frame rollers rotatably mounted to the frame spaced from each other along a longitudinal axis. The brake pedal can be moved by pivoting a handle relative to the frame for sliding a locking pin extending through the brake pedal. A ramp is pivotably mounted to the frame between an unloading position extending to the support surface and an upright position extending away from the support surface and being removably held by a pair of locking plates pivotably mounted to the frame. Rollers are rotatably mounted to the ramp and aligned with the frame rollers.

A trailer for transporting bundles such as of roofing materials is shown and described.

Roofers need to transport various roofing materials from the crane drop point to the point of use. Often times these materials are in the form of bundles. These bundles vary in size and weight but are usually in the area of 4 feet wide by 4-6 feet high and up to 8 feet long. The transport process goes very quickly and safely when complete bundles can be loaded directly from the crane to a flatbed transporter, then towed and staged at the point of use. However, reaching the point of use, there is often no crane access, and heavy bundles can be difficult and dangerous to unload.

Thus, a need exists for a transport trailer that allows safe and easy unloading of bundles from the transport trailer at the point of use and without requiring the use of a crane. The main advantage on large roofs is that complete bundles of material can be dropped off or staged at strategic locations on the roof. Then, roofers can break open the bundles and distribute and install the individual pieces at nearby locations.

### SUMMARY

This need and other problems in the field of transporting bundles are solved by providing a trailer for transporting bundles allowing complete bundles to be rolled off the end of the trailer at the point of use. Particularly, a steering assembly and a pair of transport wheels movably support a frame upon a support surface. A plurality of frame rollers is rotatably mounted to the frame about roller axes spaced from and parallel to the wheel axis. The upper circumferences of the plurality of frame rollers extend at a non-parallel angle to the support surface and downward from the leading end to the trailing end of the frame.

In one aspect, the inner end of a brake pedal pivotably mounted to the frame grips one of the frame rollers in an engaged position to inhibit rotation of that frame roller. The outer end of the brake pedal is pushed from a disengaged position to the engaged position. Additionally, a locking pin is biased into a locking aperture of the brake pedal in the engaged position and is moved by a handle pivotably mounted to the frame and to the locking pin.

In another aspect, a ramp is pivotably mounted to the trailing end of the frame and is movable between an unloading position extending to the support surface and an upright position extending away from the support surface. Additionally, the ramp can be locked in the upright position by ramp pins extending from the ramp into locking recesses of J-shaped tracks formed in a pair of lock plates. Also, a plurality of ramp rollers is rotatably mounted to the ramp parallel to and spaced from the plurality of frame rollers. Furthermore, the rollers at the trailing end of the frame and the connecting end of the ramp are in the form of two pairs of rollers aligned with each other. Further, the remaining frame rollers are arranged in pairs, with one of the pair of the remaining frame rollers being aligned in the longitudinal direction with the one pair of the two pairs of rollers at the trailing end and the connecting end.

In still other aspects, the steering assembly is pivotably connected to a front platform interconnected to the leading end of the frame. The steering axis extends generally perpendicular to a tongue extending from an axle to which wheels are rotatably connected. A storage box is located on the front platform above the steering assembly.

The following detailed description of illustrative embodiments will become clearer in connection with the drawings.

### DESCRIPTION OF THE DRAWINGS

The illustrative embodiments may best be described by reference to the accompanying drawings where:

FIG. 1 shows an exploded perspective view of a bundle transport trailer.

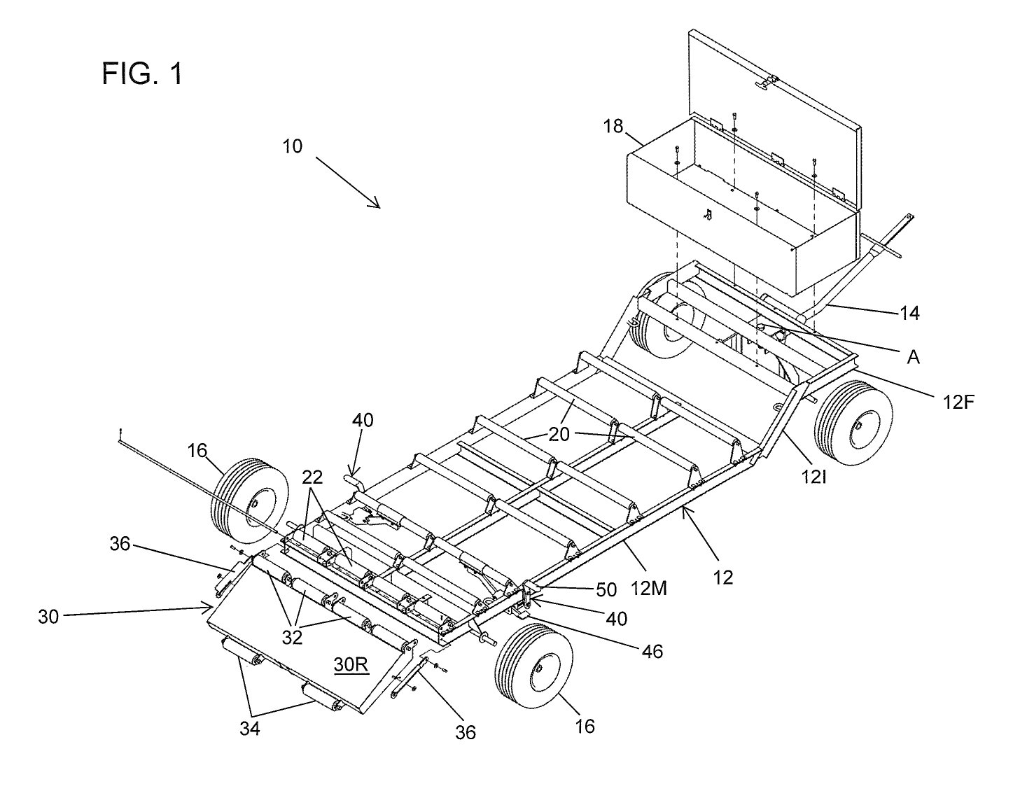

FIG. 2 shows a partial side view of the ramp of the bundle transport trailer of FIG. 1.

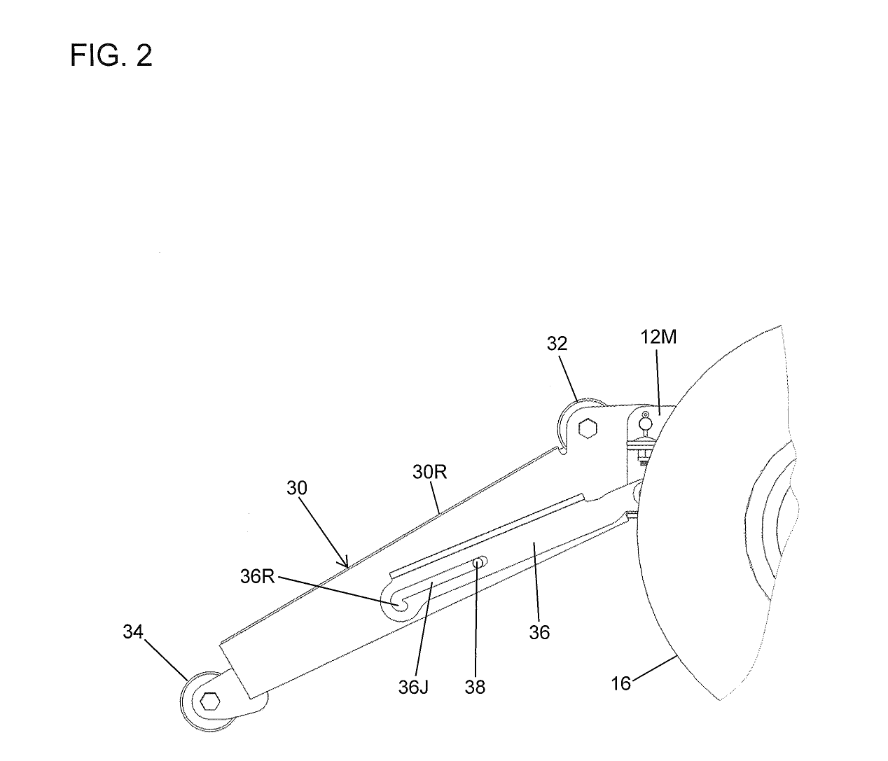

FIG. 3 shows a partial side view of the ramp of the bundle transport trailer of FIG. 1 in a different position.

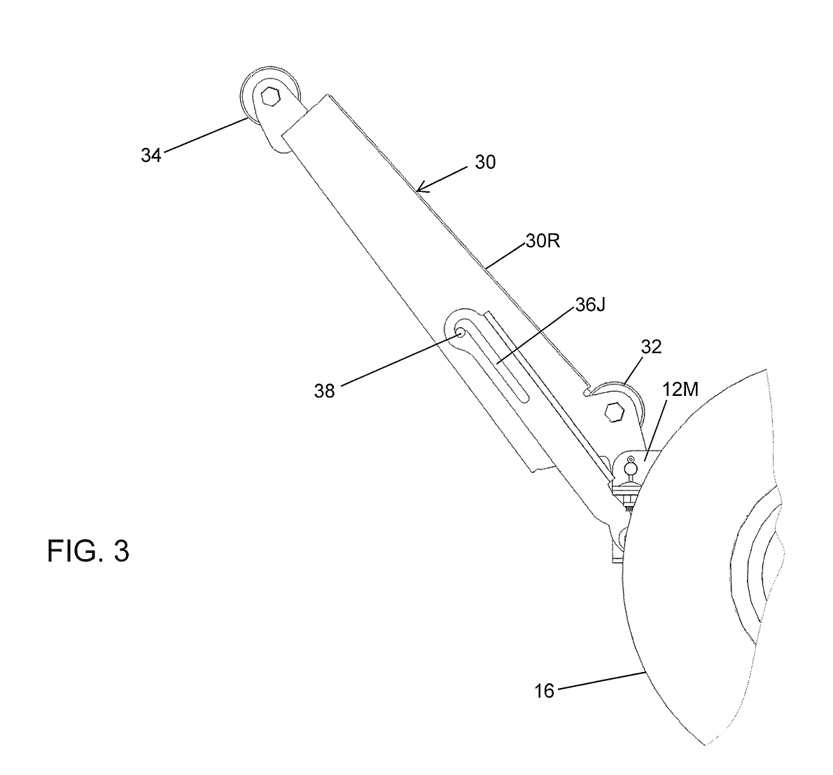

FIG. 4 shows a partial side view of the roller brake of the bundle transport trailer of FIG. 1.

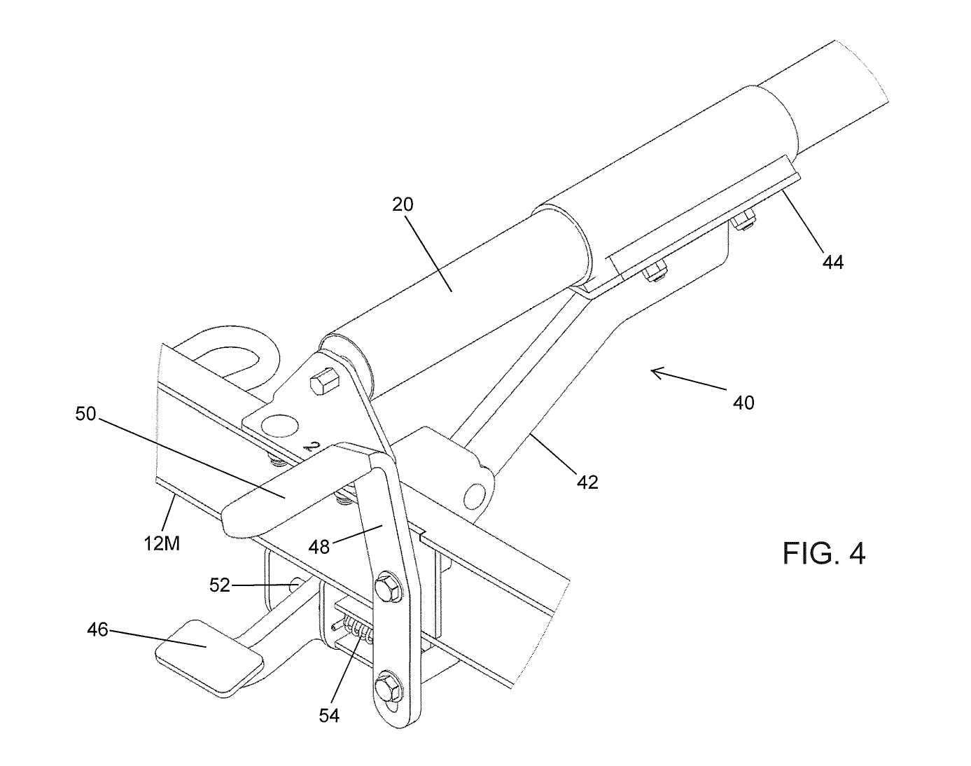

FIG. 5 shows a view of the roller brake of the bundle transport trailer of FIG. 1 in a different position.

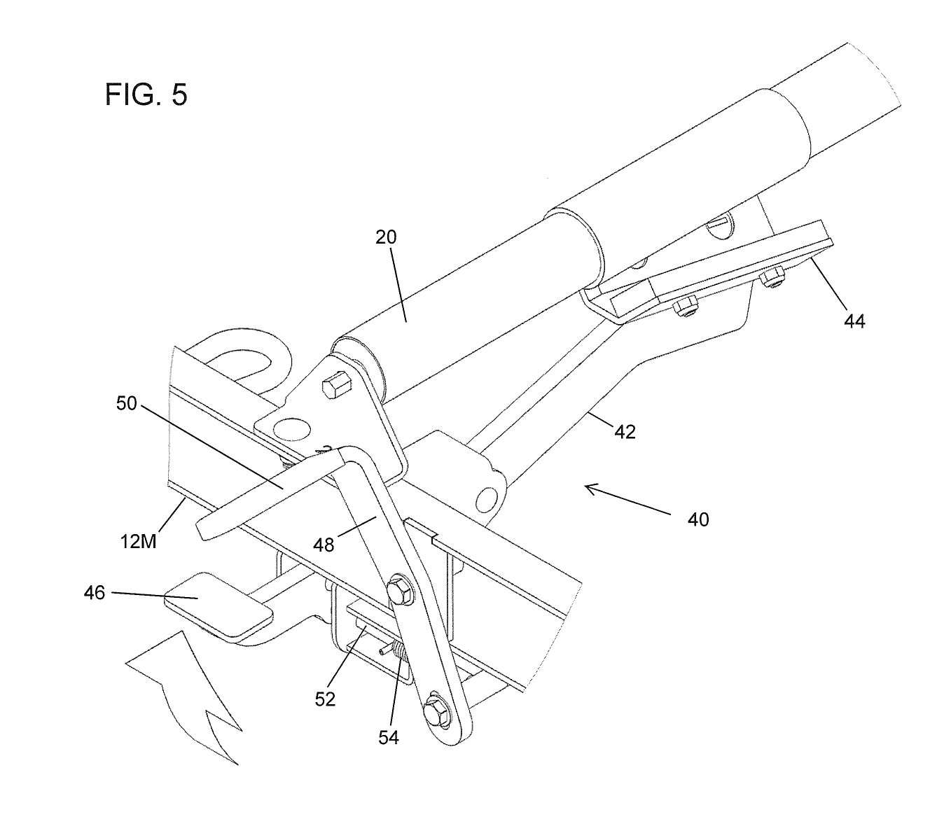

All figures are drawn for ease of explanation of the basic teachings only; the extensions of the figures with respect to number, position, relationship, and dimensions of the parts to form the illustrative embodiments will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “forward”, “rearward”, “reverse”, “front”, “back”, “height”, “width”, “length”, “end”, “side”, “horizontal”, “vertical”, and similar terms are used herein, it should be understood that these terms have reference only to the structure shown in the drawings as it would appear to a person viewing the drawings and are utilized only to facilitate describing the illustrative embodiments.

### DESCRIPTION

A trailer for transporting bundles such as of roofing materials is shown in the drawings and generally designated 10. Trailer 10 generally includes a framework 12 movably supported upon a support surface by a steering assembly 14 and a pair of transport wheels 16. Framework 12 generally includes a front platform 12F, a frame or main platform 12M including a leading end and a trailing end spaced from the leading end along a longitudinal axis, and interconnections 121 connected between front platform 12F and the leading end of main platform 12M. Front platform 12F is at a higher elevation from the support surface than main platform 12M, and a storage cabinet 18 is connected thereto. Steering assembly 14 is located below front platform 12F and adjacent and in front of the leading end of main platform 12M and is pivotably mounted to front platform 12F about a vertical axis A which is perpendicular to the longitudinal axis of main platform 12M and the support surface. Steering assembly 14 includes an axle, a tongue extending generally perpendicular to the axle, and first and second wheels rotatably connected to the axle on opposite sides of front platform 12F. Vertical axis A extends generally perpendicular to the tongue and the axle intermediate the opposite sides of front platform 12F. Storage cabinet 18 is connected to front platform 12F opposite to steering assembly 14. Transport wheels 16 are suitably rotatably secured to opposite sides of main platform 12M about an axis parallel to the support surface and perpendicular to the longitudinal axis and opposite to front platform 12F.

A plurality of pairs of frame rollers 20 is rotatably mounted to main platform 12M intermediate the transport wheels 16 and front platform 12F and having axes parallel to but spaced from the axis of transport wheels 16. Two pairs of trailing rollers 22 are rotatably mounted adjacent to the trailing end of main platform 12M about an axis parallel to but spaced from the axes of frame rollers 20 and of transport wheels 16 and located on the opposite side of the axis of transport wheels 16 than frame rollers 20. The pairs of frame and trailing rollers 20 and 22 are spaced from each other along the longitudinal axis. The upper circumferences of frame and trailing rollers 20 and 22 extend at a non-parallel angle to the support surface, downward from front platform 12F to transport wheels 16 and downward from the leading end to the trailing end of main platform 12M. Front platform 12F has an elevation above the upper circumferences of frame and trailing rollers 20 and 22.

Trailer 10 further includes a ramp 30 having a connecting end pivotably mounted to the trailing end of main platform 12M about an axis parallel to and spaced from the axes of frame and trailing rollers 20 and 22 and transport wheels 16 between an unloading position extending from the trailing end to the support surface and an upright position extending at an angle from the trailing end away from the support surface. The axis of trailing rollers 22 is located intermediate the axes of transport wheels 16 and ramp 30. Ramp 30 includes two pairs of second rollers 32, a ramp platform 30R, and a pair of first rollers 34. Second rollers 32 are rotatably mounted to the connecting end of ramp 30 about an axis parallel to but spaced from the axes of frame and trailing rollers 20 and 22, transport wheels 16 and ramp 30, aligned parallel to the longitudinal axis to correspond to trailing rollers 22, and are located intermediate trailing rollers 22 and ramp platform 30R. First rollers 34 are rotatably mounted to a free end of ramp 30 about an axis parallel to but spaced from the axes of frame, trailing, second and first rollers 20, 22 and 32, transport wheels 16 and ramp 30, with ramp platform 30R located intermediate second and first rollers 32 and 34. The free end is spaced from the connecting end of ramp 30 along the longitudinal axis, with the connecting end of ramp 30 being intermediate the trailing end of main platform 12M and the free end of ramp 30.

Ramp 30 further includes a pair of lock plates 36 having ends pivotably mounted to main platform 12M about an axis parallel to but spaced from the axes of frame, trailing, second and first rollers 20, 22, 32 and 34, transport wheels 16 and ramp 30. The opposite ends of lock plates 36 include J-shaped tracks 36J terminating in a locking recess 36R and which slideably receive ramp pins 38 extending from ramp 30 parallel to but spaced from the axes of frame, trailing, second and first rollers 20, 22, 32 and 34, lock plates 36, transport wheels 16 and ramp 30. Ramp 30 can be locked in an upright position when ramp pins 38 are slid into and retained by locking recesses 36R.

Trailer 10 further includes a pair of roller brakes 40 which grip one pair of frame rollers 20. Generally, each brake 40 includes a brake pedal 42 pivotably mounted to main platform 12M about an axis perpendicular to the axes of frame, trailing, second and first rollers 20, 22, 32 and 34, lock plates 36, transport wheels 16 and ramp 30. The inner end of brake pedal 42 includes a yoke 44 of a shape and size for gripping frame roller 20, with yoke 44 and frame roller 20 provided with suitable elements for increasing frictional engagement. The outer end includes a suitable knob 46 to be pushed for pivoting brake pedal 42 between an engaged position where yoke 44 engages frame roller 20 and a disengaged position where yoke 44 does not inhibit rotation of frame roller 20. Brake 40 further includes provisions for locking brake pedal 42 in the engaged position shown as a handle 48 pivotably mounted to main platform 12M about a handle axis parallel to but spaced from the axes of frame, trailing, second and first rollers 20, 22, 32 and 34, lock plates 36, transport wheels 16 and ramp 30 and perpendicular to the axis of brake pedal 42. The upper end of handle 48 includes a suitable grip 50. A locking pin 52 is slideably mounted to main platform 12M along a slide axis spaced from and parallel to the axis of brake pedal 42 and is pivotably attached about a pin axis to the lower end of handle 48, with the pin axis of locking pin 52 being parallel to and spaced from the handle axis of handle 48. Locking pin 52 is slideable between a locked position extending through a locking aperture formed in brake pedal 42 in the engaged position and an unlocked position located outside of brake pedal 42. The locking aperture of brake pedal 42 extends parallel to the slide axis of locking pin 52. The handle axis of handle 48 is located intermediate grip 50 and the pin axis of locking pin 52. Locking pin 52 can be biased from the unlocked position to the locked position such as by a spring 54. In the locked position, the locking pin 52 holds brake pedal 42 in the engaged position. When brake pedals 42 are in the engaged position, rotation of frame rollers 20 is inhibited such that any bundle supported on frame rollers 20 having inhibited rotation will be held against movement relative to main platform 12M.

It should be recognized that trailer 10 as shown and described includes a combination of several features which are believed to produce synergistic results. However, such features could be utilized individually in other combinations to achieve functions and advantages thereof. Likewise, although steering assembly 14 is shown and described including a single pivotal axle, steering assembly 14 can take other forms including, but not limited to, steerable dual pivotal axles.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Transport trailer comprising, in combination: a frame including a leading end and a trailing end spaced from the leading end along a longitudinal axis; a steering assembly adjacent to the leading end and pivotably about at least one steering axis perpendicular to the longitudinal axis; a pair of transport wheels located on opposite sides of the frame and rotatable about a wheel axis perpendicular to the longitudinal and at least one steering axes, with the steering assembly and the pair of transport wheels movably supporting the frame upon a support surface; a plurality of frame rollers rotatably mounted to the frame about roller axes parallel to but spaced from the wheel axis, with the plurality of frame rollers being spaced from each other along the longitudinal axis, with upper circumferences of the plurality of frame rollers extending at a non-parallel angle to the support surface and downward from the leading end to the trailing end; and a brake pedal pivotably mounted to the frame about a brake axis perpendicular to the roller axes between an engaged position and a disengaged position, with the brake pedal including an inner end configured to grip one of the plurality of frame rollers and an outer end configured to being pushed for pivoting the brake pedal from the disengaged position to the engaged position, with the brake pedal in the engaged position inhibiting rotation of the one of the plurality of frame rollers.

2. The transport trailer of claim 1, further comprising, in combination: a locking pin slideably mounted to the frame along a slide axis parallel to the brake axis between a locked position and an unlocked position, with the brake pedal including a locking aperture extending parallel to the slide axis, with the locking pin in the locked position slideably received in the locking aperture with the brake pedal in the engaged position.

3. The transport trailer of claim 2, wherein the locking pin is biased from the unlocked position to the locked position.

4. The transport trailer of claim 3, further comprising, in combination: a handle pivotably mounted to the frame about a handle axis parallel to and spaced from the roller axes, with the locking pin pivotably attached to the handle about a pin axis parallel to and spaced from the handle axis, with the handle including a grip, with the handle axis located intermediate the grip and the pin axis.

5. The transport trailer of claim 4, further comprising, in combination: a ramp pivotably mounted to the trailing end of the frame about a ramp axis spaced from and parallel to the wheel axis between an unloading position extending from the trailing end to the support surface and an upright position extending at an angle from the trailing end away from the support surface.

6. The transport trailer of claim 5, further comprising, in combination: a pair of lock plates pivotably mounted to the frame about a lock axis parallel to and spaced from the ramp axis, with each lock plate including J-shaped tracks terminating in a locking recess; and ramp pins extending from the ramp parallel to and spaced from the ramp axis and into the J-shaped tracks of the pair of lock plates, with the ramp pins located in the locking recess in the upright position.

7. The transport trailer of claim 6, further comprising, in combination: a plurality of ramp rollers rotatably mounted to the ramp about rotation axes parallel to and spaced from the ramp axis, with the ramp including a connecting end and a free end spaced from the free end along the longitudinal axis, with the connecting end being intermediate the trailing end and the free end, with the plurality of ramp rollers including at least one first roller adjacent the free end and at least one second roller adjacent the connecting end.

8. The transport trailer of claim 7, wherein the at least one second roller comprises two pairs of second rollers rotatably mounted to the ramp about a same rotation axis; wherein the plurality of frame rollers includes two pairs of trailing rollers rotatably mounted to the frame about a same roller axis adjacent to the trailing end, with the two pairs of second rollers being aligned parallel to the longitudinal axis with the two pairs of trailing rollers.

9. The transport trailer of claim 8, wherein the plurality of frame rollers includes a plurality of pairs of support rollers, with each pair of support rollers rotatably mounted to the frame about a same roller axis, and with one of each pair of support rollers being aligned parallel to the longitudinal axis with a corresponding one of the two pairs of trailing rollers.

10. The transport trailer of claim 9, further comprising, in combination: a front platform; and interconnections connected between the leading end and the front platform, with the front platform having an elevation above the upper circumferences of the plurality of frame rollers, with the steering assembly located below the front platform and opposite the leading end than the trailing end.

11. The transport trailer of claim 10, further comprising, in combination: a storage cabinet connected to the front platform opposite the steering assembly; and wherein the steering assembly includes an axle, a tongue extending generally, perpendicular to the axle, and first and second wheels rotatably connected to the axle on opposite sides of the front platform, with the at least one steering axis extending generally perpendicular to the tongue and the axle intermediate the opposite sides of the front platform.

12. The transport trailer of claim 1, further comprising, in combination: a ramp pivotably mounted to the trailing end of the frame about a ramp axis spaced from and parallel to the wheel axis between an unloading position extending from the trailing end to the support surface and an upright position extending at an angle from the trailing end away from the support surface.

13. The transport trailer of claim 12, further comprising, in combination: a pair of lock plates pivotably mounted to the frame about a lock axis parallel to and spaced from the ramp axis, with each lock plate including J-shaped tracks terminating in a locking recess; and ramp pins extending from the ramp parallel to and spaced from the ramp axis and into the J-shaped tracks of the pair of lock plates, with the ramp pins located in the locking recess in the upright position.

14. The transport trailer of claim 13, further comprising, in combination: a plurality of ramp rollers rotatably mounted to the ramp about rotation axes parallel to and spaced from the ramp axis, with the ramp including a connecting end and a free end spaced from the free end along the longitudinal axis, with the connecting end being intermediate the trailing end and the free end, with the plurality of ramp rollers including at least one first roller adjacent the free end and at least one second roller adjacent the connecting end.

15. The transport trailer of claim 14, wherein the at least one second roller comprises two pairs of second rollers rotatably mounted to the ramp about a same rotation axis; wherein the plurality of frame rollers includes two pairs of trailing rollers rotatably mounted to the frame about a same roller axis adjacent to the trailing end, with the two pairs of second rollers being aligned parallel to the longitudinal axis with the two pairs of trailing rollers.

16. The transport trailer of claim 15, wherein the plurality of frame rollers includes a plurality of pairs of support rollers, with each pair of support rollers rotatably mounted to the frame about a same roller axis, and with one of each pair of support rollers being aligned parallel to the longitudinal axis with a corresponding one of the two pairs of trailing rollers.

17. The transport trailer of claim 16, further comprising, in combination: a front platform; and interconnections connected between the leading end and the front platform, with the front platform having an elevation above the upper circumferences of the plurality of frame rollers, with the steering assembly located below the front platform and opposite the leading end than the trailing end.

18. The transport trailer of claim 17, further comprising, in combination: a storage cabinet connected to the front platform opposite the steering assembly; and wherein the steering assembly includes an axle, a tongue extending generally perpendicular to the axle, and first and second wheels rotatably connected to the axle on opposite sides of the front platform, with the at least one steering axis extending generally perpendicular to the tongue and the axle intermediate the opposite sides of the front platform.

19. The transport trailer of claim 12, further comprising, in combination: a plurality of ramp rollers rotatably mounted to the ramp about rotation axes parallel to and spaced from the ramp axis, with the ramp including a connecting end and a free end spaced from the free end along the longitudinal axis, with the connecting end being intermediate the trailing end and the free end, with the plurality of ramp rollers including at least one first roller adjacent the free end and at least one second roller adjacent the connecting end.

20. The transport trailer of claim 19, wherein the at least one second roller comprises two pairs of second rollers rotatably mounted to the ramp about a same rotation axis; wherein the plurality of frame rollers includes two pairs of trailing rollers rotatably mounted to the frame about a same roller axis adjacent to the trailing end, with the two pairs of second rollers being aligned parallel to the longitudinal axis with the two pairs of trailing rollers, wherein the plurality of frame rollers includes a plurality of pairs of support rollers, with each pair of support rollers rotatably mounted to the frame about a same roller axis, and with one of each pair of support rollers being aligned parallel to the longitudinal axis with a corresponding one of the two pairs of trailing rollers.
